(19) United States
(12) Patent Application Publication
(10) Pub. No.: US 2025/0326937 A1
(43) Pub. Date: Oct. 23, 2025

(54) INORGANIC THERMAL BARRIER COATINGS

(71) Applicant: 3M INNOVATIVE PROPERTIES COMPANY, St. Paul, MN (US)

(72) Inventors: Dinh Ba Le, St. Paul, MN (US); Taisiya Skorina, Woodbury, MN (US); Daniel S. Bates, Chisago City, MN (US); Mark A. Fairbanks, Lino Lakes, MN (US); Matthew T. Johnson, Woodbury, MN (US); Sebastian Goris, Inver Grove Heights, MN (US)

(21) Appl. No.: 18/868,377

(22) PCT Filed: Jun. 1, 2023
(86) PCT No.: PCT/IB2023/055658

§ 371 Date: Nov. 22, 2024

Related U.S. Application Data
(60) Provisional application No. 63/367,244, filed on Jun. 29, 2022.

(51) Int. Cl. C09D 1/02; C09D 5/18; C09D 7/40; C09D 7/61; H01M 10/658; H01M 50/276; H01M 50/293

(52) U.S. Cl. CPC C09D 1/02; C09D 5/18; C09D 7/61; C09D 7/70; H01M 10/658; H01M 50/276; H01M 50/293

(57) ABSTRACT

Inorganic thermal barrier coatings and articles containing the coatings that can be used as impact resistant thermal barriers in high temperature applications. The coatings comprises a filler, an alkali silicate and a hardener, where the filler comprises calcium silicate, zirconium silicate, calcium phosphate, or combinations thereof. Articles containing the coatings can be made by mixing together the filler, the alkali silicate and the hardener to form a coating solution, applying the coating solution to at least a first major surface of a substrate, and hardening the coating solution by drying and curing the coating solution.

### BACKGROUND

An increasing demand for hybrid and fully electric vehicles is also leading to an increasing demand for safer, more efficient rechargeable batteries to fuel those electric vehicles. Such batteries, including the lithium-ion battery, are typically made up of several battery modules, and each battery module comprises many interconnected individual battery cells. When one cell in a battery module is damaged or faulty in its operation, the temperature within the cell may increase faster than heat can be removed. If the temperature increase remains unchecked, a catastrophic phenomenon called thermal runaway can occur resulting in a fire and blasts of particles as hot as 1000° C. or more. The resulting fire can spread very quickly to neighboring cells and subsequently to cells throughout the entire battery as a chain reaction. These fires can be potentially large and can endanger occupants of the vehicle or structures in which these batteries are located.

### SUMMARY

One solution to reducing the potential for a catastrophic thermal runaway event is to use coatings to protect the components of a battery from the high temperatures and high velocity particles often associated with such events. In contrast to traditional thermal insulators (e.g., mica), coatings are relatively easy to apply, conform to the substrates on which they are applied, and take up minimal space within the article.

Inorganic thermal barrier coatings comprising an alkali silicate-based binder matrix loaded with various inorganic particles are currently being investigated for use in electric vehicles. However, these alkali silicates can exhibit several drawbacks. For example, alkali silicates tend to be water soluble and subject to degradation in humid environments. Additionally, hydrated alkali silicates have a tendency to intumesce at temperatures ranging from 100° C. to 150° C. and typically need to be dried slowly to prevent foaming upon removal of water. This leads to longer drying times, which can impact application efficiencies.

The present disclosure provides coatings and articles comprising such coatings that exhibit high impact resistance (i.e. resistance to damage due to particle impact) and high thermal transfer resistance at elevated temperatures (e.g., up to 1200° C.) while also addressing one or more of the deficiencies identified above. Such articles can be used, for example, as impact resistant thermal barriers in the construction of battery components to isolate fires and reduce the chance for a catastrophic thermal runaway.

In one embodiment, the present disclosure provides a coating comprising: a filler; an alkali silicate; and a hardener, wherein the filler comprises calcium silicate, zirconium silicate, calcium phosphate, or combinations thereof, and wherein the hardener comprises aluminum phosphate AlPO₄, aluminum phosphate monobasic Al(H₂PO₄)₃, aluminum metaphosphate Al(PO₃)₃, non-stoichiometric aluminum phosphate [Al₂O₃]ₓ[P₂O₅]_{y}, calcium phosphate monobasic, magnesium phosphate monobasic, alkali metal bicarbonates (e.g., lithium bicarbonate, sodium bicarbonate, potassium bicarbonate), calcium chloride, calcium carbonate, calcium oxide, zinc chloride, zinc oxide, zinc borate, calcium hydroxide, magnesium hydroxide, aluminum hydroxide, calcium sulfate, magnesium sulfate, aluminum sulfate, monosodium phosphate, sodium borate, boric acid, phosphoric acid, carboxylic acid, CO₂ gas, sodium fluorosilicate or combinations thereof.

In another embodiment, the present disclosure provides an article comprising: a substrate having a first major surface and a second major surface opposite the first major surface; and a hardened coating of the present disclosure on at least the first major surface of the substrate.

In a further embodiment, the present disclosure provides a method of making the article of the present disclosure, the method comprising: mixing together the filler, the alkali silicate and the hardener to form a coating solution; applying the coating solution to at least the first major surface of the substrate; and hardening the coating solution by drying and curing the coating solution.

In yet a further embodiment, the present disclosure provides a battery comprising a plurality of battery cells separated from one another by a gap, and the article of the present disclosure disposed in the gap between the battery cells.

In another embodiment, the present disclosure provides a battery comprising a compartment lid having an inner and outer major surface, the inner major surface covering a plurality of battery cells, and the article of the present disclosure disposed on the inner surface of the compartment lid.

As used herein:

The term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The terms “a,” “an,” and “the” are used interchangeably with “at least one” to mean one or more of the components being described.

The term “and/or” means one or all of the listed elements or a combination of any two or more of the listed elements.

The term “some embodiments” means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments.

The terms “preferred” and “preferably” refer to embodiments of the disclosure that may afford certain benefits, under certain circumstances; however, other embodiments may also be preferred, under the same or other circumstances. Furthermore, the recitation of one or more preferred embodiments does not imply that other embodiments are not useful, and is not intended to exclude other embodiments from the scope of the disclosure.

All numbers are assumed to be modified by the term “about”. As used herein in connection with a measured quantity, the term “about” refers to that variation in the measured quantity as would be expected by the skilled artisan making the measurement and exercising a level of care commensurate with the objective of the measurement and the precision of the measuring equipment used.

The recitations of numerical ranges by endpoints include all numbers subsumed within that range as well as the endpoints (e.g., 1 to 5 includes 1, 1.5, 2, 2.75, 3, 3.80, 4, 5, etc.). The phrase “up to” a number (e.g., up to 50) includes the number (e.g., 50).

The above summary of the present disclosure is not intended to describe each disclosed embodiment or every implementation of the present disclosure. The description that follows more particularly exemplifies illustrative embodiments.

### DETAILED DESCRIPTION

In the following description of illustrative embodiments, reference is made to the accompanying figures of the drawing which form a part hereof, and in which are shown, by way of illustration, specific embodiments. It is to be understood that other embodiments may be utilized and structural changes may be made without departing from the scope of the present invention.

Coatings of the present application comprise a filler, an alkali silicate, and a hardener. A solution of the coating is typically applied to one or more surfaces of a substrate and hardened by dehydration and curing. The resultant article can be used to create a high impact resistant thermal barrier that operates at temperatures as high as 1200° C. In some embodiments, the article can be used as a thermal barrier between cells in a battery, including cells in a battery module or a battery pack, to reduce the potential for catastrophic thermal runaway events. Additionally, or alternatively, the article can be used as a protective inner surface of a battery (e.g., inner surface of lid). Although the coatings and articles disclosed herein are discussed in the context of electric vehicle battery applications, it should be understood that the coatings and articles can be used in other applications desiring impact resistance and/or thermal transfer, as well.

The filler of the coatings disclosed herein comprises calcium silicate, zirconium silicate, calcium phosphate, or combinations thereof. The calcium silicate can be any of a number of stoichiometric mixtures of CaO and SiO₂, including calcium metasilicate (CaSiO₃) and calcium orthosilicate (Ca₂SiO₄). The zirconium silicate can be any of a number of stoichiometric mixtures of ZrO and SiO₂, including zirconium metasilicate, Zr(SiO₃)₂, and zirconium orthosilicate, ZrSiO₄. The calcium phosphate can be a variety of stoichiometric combinations of the calcium ion and phosphate ions (e.g., phosphate and hydrogen phosphate), including tricalcium phosphate, Ca₃ (PO₄)₂, calcium pyrophosphate, Ca₂P₂O₇, and calcium hydrogen phosphate, CaHPO₄. However, it was found that calcium dihydrogen phosphate did not work well in these systems. In some embodiments, the filler comprises calcium silicate, calcium phosphate, or a combination thereof. In some preferred embodiments, the filler comprises calcium silicate, which has been found to be biodegradable, exhibit lower thermal conductivity values, and have a fibrous structure that enhances mechanical stability.

The filler generally contributes to the thermal stability and insulation performance of the coating. In some embodiments, the coating comprises at least 30 wt. %, at least 35 wt. %, at least 40 wt. %, at least 45 wt. %, at least 50 wt. %, at least 55 wt. %, at least 60 wt. %, at least 65 wt. %, at least 70 wt. %, or at least 75 wt. % filler based upon the percentage of solids in the coating. In some embodiments, the coating comprises up to 80 wt. %, up to 75 wt. %, up to 70 wt. %, up to 65 wt. %, up to 60 wt. %, up to 55 wt. %, or up to 50 wt. % filler based upon the percentage of solids in the coating. In some embodiments, the coating comprises 30 wt. % to 80 wt. %, more particularly 40 wt. % to 80 wt. %, even more particularly 50 wt. % to 80 wt. % filler based upon the percentage of solids in the coating. The term “solids”, as used herein in the context of percentage of solids in the coating, means the components that remain in the coating after dehydration and curing. Solvents (e.g., water) driven off during formation of the hardened coat are not considered solids. Since the solvent does not form part of the solids in the coating, the solids content will be approximately the same before and after a coating is dried and cured.

The coating further comprises an alkali silicate that may function as an inorganic binder. The term “silicate”, as used herein, means a salt in which the anion contains both silicon and oxygen. Silicates include metasilicates (SiO₃²⁻) and orthosilicate (SiO₄⁴⁻). Exemplary alkali silicates include sodium silicate, potassium silicate, lithium silicate, or combinations thereof. In some embodiments, the alkali silicate is a metasilicate having the formula M₂SiO₃, wherein M is Na, K or Li. In other embodiments, the alkali silicate is a polysilicate having the formula M₂O(SiO₂)ₓ·yH₂O, wherein M is selected from Li, Na, or K, x is between 1 and 15, preferably between 2 and 9, and y is ≥0. In some embodiments, the alkali silicate is sodium silicate or potassium silicate. In some further embodiments, the alkali silicate is Na₂SiO₃. The choice of silicate may depend upon the desired application. For example, adhesion between the coating and a substrate can be influenced by the nature of the alkali silicate, where adhesion typically decreases in order of sodium silicate, potassium silicate, and lithium silicate. Therefore, in some embodiments, sodium silicate may be the preferred alkali silicate. However, coatings made with potassium silicate tend to exhibit greater moisture resistivity and may be preferable in environments where the coating may be exposed to humidity. Therefore, in some embodiments, potassium silicate may be the preferred alkali silicate. In some embodiments, the coating comprises at least 20 wt. %, at least 25 wt. %, at least 30 wt. %, at least 35 wt. %, at least 40 wt. %, at least 45 wt. %, at least 50 wt. %, at least 55 wt. %, at least 60 wt. %, or at least 65 wt. % alkali silicate based upon the percentage of solids in the coating. In some embodiments, the coating comprises up to 70 wt. %, up to 65 wt. %, up to 60 wt. %, up to 55 wt. %, up to 50 wt. %, up to 45 wt. %, or up to 40 wt. % alkali silicate based upon the percentage of solids in the coating. In some embodiments, the coating comprises 20 wt. % to 70 wt. %, more particularly 20 wt. % to 60 wt. %, even more particularly 25 wt. % to 45 wt. % alkali silicate based upon the percentage of solids in the coating.

The coating also includes a hardener comprising aluminum phosphate AlPO₄, aluminum phosphate monobasic Al(H₂PO₄)₃, aluminum metaphosphate Al(PO₃)₃, non-stoichiometric aluminum phosphate [Al₂O₃]ₓ[P₂O₅]_{y}, calcium phosphate monobasic, magnesium phosphate monobasic, alkali metal bicarbonates (e.g., lithium bicarbonate, sodium bicarbonate, potassium bicarbonate), calcium chloride, calcium carbonate, calcium oxide, zinc chloride, zinc oxide, zinc borate, calcium hydroxide, magnesium hydroxide, aluminum hydroxide, calcium sulfate, magnesium sulfate, aluminum sulfate, monosodium phosphate, sodium borate, boric acid, phosphoric acid, carboxylic acid, CO₂ gas, sodium fluorosilicate or combinations thereof. In some embodiments, the hardener comprises aluminum phosphate AlPO₄, aluminum phosphate monobasic Al(H₂PO₄)₃, aluminum metaphosphate Al(PO₃)₃, non-stoichiometric aluminum phosphate [Al₂O₃]ₓ[P₂O₅]_{y}, or combinations thereof. In some embodiments, the hardener comprises aluminum metaphosphate. In some embodiments, the coating comprises at least 10 wt. %, at least 15 wt. %, at least 20 wt. %, or at least 25 wt. % hardener based upon the percentage of solids in the coating. In some embodiments, the coating comprises up to 30 wt. %, up to 25 wt. %, up to 20 wt. %, or up to 15 wt. % hardener based upon the percentage of solids in the coating. In some embodiments, the coating comprises 10 wt. % to 30 wt. %, more particularly 10 wt. % to 20 wt. % hardener based upon the percentage of solids in the coating.

The coating of the present disclosure may optionally comprise fibers. Fibers can be used to enhance the mechanical properties of the coating, including increasing the blast or impact resistance of the coating and articles to which it has been applied. The fibers are typically made of high refractory glass or ceramic materials. A “refractory material” or “refractory”, as used herein, is a material that is resistant to decomposition by heat, pressure, or chemical attack, and retains strength and form at high temperatures. The fibers typically have an aspect ratio ranging from 50:1 to 500:1. Fibers having an aspect ratio less than 50:1 behave more like a powder and provide little-to-no performance benefit. Fibers having an aspect ratio greater than 500:1 typically have difficulty dispersing within the coating and can produce a rough (e.g., lumpy) surface coating. In some embodiments, the fibers have an average length ranging from 1/32 inch to ¼ inch.

Exemplary fibers include E-glass fibers, S-glass fibers, R-glass fibers, ECR-glass fibers, basalt fibers, ceramic fibers, polycrystalline fibers, silicate fibers, alumina fibers, silica fibers, alumina-silica fibers, carbon fibers, silicon carbide fibers, boron silicate fibers, or combinations thereof. The fibers may include annealed melt-formed ceramic fibers, sol-gel formed ceramic fibers, polycrystalline ceramic fibers, glass fibers, including annealed glass fibers or non-bio-persistent fibers. Suitable commercially available fibers include 3M™ Nextel™ fibers (e.g., 610 grade fibers available from 3M Company in St. Paul, MN), 1/32″ Milled Glass Fibers (available from FIBREGLAST® in Brookville, OH) and ⅛″ Chopped Glass Fibers (available under Product Code 01014 from PPG Industries in Pittsburgh, PA). While glass fibers typically have lower thermal conductivity than Nextel fibers, Nextel fibers are typically a higher refractory material. Therefore, in some preferred embodiments, the fiber is a Nextel™ fiber. In some embodiments, the coatings comprises at least 1 wt. %, at least 3 wt. %, at least 5 wt. %, at least 10 wt. %, at least 15 wt. %, at least 20 wt. %, or at least 25 wt. % fibers based on the percentage of solids in the coating.

In some embodiments, the coating comprises up to 30 wt. %, up to 25 wt. %, up to 20 wt. % of the fibers based upon the percentage of solids in the coating. In some embodiments, the coating typically comprises 1 wt. % to 30 wt. % fibers based on the percentage of solids in the coating. Less than 1 wt. % and the fibers provide little-to-no performance benefit. Greater than 30 wt. % tends to inhibit the flowability of the coating and result in a lumpy (i.e. not smooth) coating.

Coatings of the present application may further include optional additives. Exemplary additives include defoamers, surfactants, rheological modifiers, forming aids, pH-adjusting materials, or combinations thereof. Exemplary rheological modifiers can be organic compound, including natural or modified organic compounds selected from polysaccharides (e.g., xanthan, carrageenan, pectin, gellan, xanthan gum, diuthan, cellulose ethers such as carboxymethyl cellulose, methyl cellulose, ethyl cellulose and hydroxyethyl cellulose), proteins and polyvinyl alcohols. In some embodiments, the rheological modifier comprises fumed silica, fumed titania, fumed alumina, or combinations thereof. In some embodiments, the coating comprises at least 0.5 wt. %, at least 1 wt. %, at least 1.5 wt. %, at least 2 wt. %, at least 2.5 wt. %, at least 3 wt. %, at least 3.5 wt. %, at least 4 wt. %, at least 4.5 wt. %, or at least 5 wt. % additives based upon the percentage of solids in the coating. In some embodiments, the coating comprises up to 10 wt. %, up to 9 wt. %, up to 8 wt. %, up to 7 wt. %, up to 6 wt. %, up to 5 wt. %, up to 4 wt. %, or up to 3 wt. % additives based upon the percentage of solids in the coating. In some embodiments, the coating comprises 0.5 wt. % to 10 wt. %, more particularly 0.5 wt. % to 5 wt. %, even more particularly 0.5 wt. % to 2 wt. % additives based upon the percentage of solids in the coating.

The above coatings can be applied to a substrate to create articles exhibiting high impact and high thermal transfer resistance in high temperature applications. The substrates are typically flame resistant and may include flame resistant paper (e.g., inorganic paper or mica based paper), an inorganic fabric, or flame resistant boards (e.g., inorganic fiber boards or mica boards or sheets). Inorganic fabrics may comprise E-glass fibers, R-glass fibers, ECR-glass fibers, basalt fibers, ceramic fibers, silicate fibers, Nextel™ fibers, steel filaments, or combinations thereof. The fibers in the inorganic fabric may be chemically treated. The fabrics may, for example, be a woven or nonwoven mat, a felt, a cloth, a knitted fabric, a stitch bonded fabric, a crocheted fabric, an interlaced fabric, or combinations thereof. Substrates may also include flame resistant polymers, including thermoplastic resins, thermosetting resins, or glass-fiber reinforced resins (e.g., polyester). Substrates may further include metals or metal alloys, including aluminum, steel, or stainless steel. In some embodiments, the substate is aluminum. Substrates may comprise a single layer structure (e.g., sheets or foils) or a multi-layered structure comprising one or more of the forementioned materials.

In one method, the articles are made by mixing together the filler, the alkali silicate and the hardener to form a coating solution, applying the coating solution to at least a first major surface of the substrate, and hardening the coating solution by drying and curing the coating solution. The term “hardened” as used in this context means that the coating has been dried (dehydrated) and cured to form an inorganic three-dimensional network. The coating layer can be applied by spraying, brushing, knife coating, nip coating, or dip coating, or the like in thicknesses of, for example, 0.1 mm to 15 mm. The coating solution is dried at a temperature of no more than 100° C. (by e.g., air-convective oven, infrared or microwave). The coating solution is cured at a temperature of at least 100° C.

Articles of the present disclosure comprise a substrate and the hardened coating on at least one major surface. In some embodiments, the hardened coating encapsulates the entire substrate. The thickness of the coating will depend upon the desired application. For example, thinner coatings can be used for applications involving lower temperatures and/or lower potential particle blast forces. Thicker coatings would be used for higher temperature applications and/or higher potential particle blast forces. In some embodiments, the hardened coating has a thickness in the range of 0.1 mm to 6 mm.

Articles of the present application may be used in a variety of high impact, high temperature applications. For example, articles of the present disclosure may be used as impact resistant thermal barriers disposed in the gap between battery cells in an electric vehicle battery (e.g., in a battery module or a batter pack). In addition, or alternatively, the coatings or articles of the present disclosure may be disposed on the inner surface of the casing of a battery (e.g., a battery module or a battery pack), including the inner surface of a compartment lid or the inner surface of vent passages for exhaust gas. Further, the coatings and articles of the present disclosure may be used to protect a wide variety of components used in high voltage equipment, such as busbars used for high current power distribution.

### EXAMPLES

Objects and advantages of this invention are further illustrated by the following examples, but the particular materials and amounts thereof recited in these examples, as well as other conditions and details, should not be construed to unduly limit this invention. These examples are merely for illustrative purposes only and are not meant to be limiting on the scope of the appended claims.

TABLE 1
Materials Used in the Examples

| Abbreviation | Description and Source |
|---|---|
| Calcium | Calcium silicate powder, obtained from George C. |
| Silicate | Brandt Inc., Saint Paul, MN, under trade |
| | designation VANSIL W-20. |
| Sodium | Sodium silicate solution (42.92 wt. % in water), |
| Silicate | obtained from PQ Corporation, Malvern, PA, under |
| | trade designation K SODIUM SILIATE. |
| Aluminum | Aluminum phosphate powder, obtained from Budenheim, |
| Phosphate | Budenheim, Germany, under trade designation |
| | FABUTIT 206. |
| Fumed | Nano alumina powder, obtained from EVONIK Corp., |
| Alumina | NJ, USA, under trade designation Aeroxide Alu C. |
| Calcium | Calcium phosphate powder obtained from Sigma-Aldrich., |
| Phosphate | MA, USA, Catalog number 21218 |

### Torch and Grit Test Method

A sample panel was prepared by applying a coating from select Examples provided below to one side of the panel (i.e. the front side) and applying a black, high temperature paint, to the other side of the panel (i.e. the backside).

A hydrogen/oxygen torch, including a customized hydrogen/oxygen burner obtained from Bethlehem Apparatus, Hellertown, PA having a central channel for particulates and a ring of outer ports for fuel and oxidizer feeds, was equilibrated to a designed flame temperature of 1200° C. as measured by a thermocouple inserted into the flame cone one inch (2.54 cm) from the face of the torch. The sample panel was positioned 2.38 inches (6.03 cm) from the torch, with the frontside of the panel facing the torch. A FLIR IR camera (Model T440) was positioned to monitor the backside of the sample panel, including a visual of the backside of the panel and the temperature of the backside of the panel. Only temperatures exceeding 200° C. were recorded.

The frontside of the panel was simultaneously subjected to the torch flame at a temperature of 1200° C. and to a series of blasts from a stream of 120 grit aluminum oxide abrasive media powered by a 35 psi (241.32 KPa) compressed air source aligned along the same axis as the torch. Each blast cycle consisted of 10 seconds of grit exposure followed by a 10 second break; the hot flame temperature was maintained throughout. The blast cycle was repeated until penetration of the sample panel by the abrasive media or 16 blasts, whichever came first. The flame temperature, the backside temperature, and the number of blast cycles were recorded.

### Water-Sensitivity Test

A 3-5 g dried sample (typically 1 to 2 cm wide, 4 to 6 cm long, 1 to 2 mm thick) was immersed in 97 g deionized water in a 8-oz glass bottle with cap closed loosely to avoid pressure build up when subjected to high temperature. The bottle was then placed in a 85° C. oven and the sample monitored for degradation. Degradation was evidenced by the disintegration of the sample into smaller pieces and a cloudy appearance in the water. Water was added to the sample in the glass bottle on occasion to compensate for evaporation.

### Example 1 (EX1)

A coating solution was made by mixing 50.00 g calcium silicate powder, 81.55 g sodium silicate solution (42.92% solid), and 21.11 g dispersion of aluminum phosphate in water (66.67% solid) using a high shear mixer (Speedmixer DAC 600/Flack Tek Inc.). The solution was then coated on aluminum plates (0.05 inches thick, 6 inches wide and 6 inches long) with a coating gap of 1.91 mm and air-dried for 5 to 15 minutes. The coating was further dried in an air convection using the following temperature profile: 95° C. for 30 minutes; then ramped to 120° C. at 5° C. per minute and maintained at 120° C. for 30 minutes; then ramped to 150° C. at 5° C. per minute and maintained at 150° C. for 30 minutes.

The solid composition of the resultant coating was 50 wt. % calcium silicate, 35 wt. % sodium silicate and 15 wt. % aluminum phosphate. The areal mass density of the dried coating was 1924 g/m².

The coating was subjected to the Torch and Grit Test described above. Results are provided in Table 3. The aluminum plate did not melt, and the coating showed minimal erosion (i.e., a small amount of coating was removed but the aluminum plate was not exposed through the coating).

### Examples 2-5 (EX2-EX5)

EXS2-5 were prepared as described above for EX1 using the ingredients in Table 2. The areal densities of the resultant coating and results from the Torch and Grit Test are summarized in Table 3.

TABLE 2
Coating Solution Ingredients

| | | | Sodium | Aluminum | | |
|---|---|---|---|---|---|---|
| | | Ceramic | Silicate | Phosphate | Fumed | |
| Exam- | Ceramic | Filler | Solution | Solution | Alumina | Water |
| ple | Filler | (g) | (g) | (g) | (g) | (g) |
| EX1 | Calcium | 50 | 81.55 | 22.5 | None | None |
| | Silicate | | | | | |
| EX2 | Calcium | 60 | 65.24 | 18 | None | None |
| | Silicate | | | | | |
| EX3 | Calcium | 48 | 81.55 | 22.5 | 2 | None |
| | Silicate | | | | | |
| EX4 | Calcium | 40 | 97.86 | 27 | 2 | None |
| | Silicate | | | | | |
| EX5 | Calcium | 100 | 174.74 | 34.72 | None | None |
| | Phosphate | | | | | |

TABLE 3
Coating Composition, Coating Areal Density, and Torch and Grit Test Results

| | | | Sodium | Aluminum | Fumed | Coating | |
|---|---|---|---|---|---|---|---|
| | | Filler | Silicate | Phosphate | Alumina | Areal | Number |
| | | Solid | Solid | Solid | Solid | Density | of Blasts |
| Example | Filler | (wt. %) | (wt. %) | (wt. %) | (wt. %) | (g/m²) | Survived |
| EX1 | Calcium | 50 | 35 | 15 | None | 1754 | 16 |
| | silicate | | | | | | |
| EX2 | Calcium | 60 | 28 | 12 | None | 1924 | 16 |
| | silicate | | | | | | |
| EX3 | Calcium | 48 | 35 | 15 | 2 | 1828 | 16 |
| | silicate | | | | | | |
| EX4 | Calcium | 39.22 | 41.17 | 17.65 | 1.96 | 1615 | 16 |
| | silicate | | | | | | |
| EX5 | Calcium | 50 | 37.5 | 12.5 | None | 2331 | 16 |
| | phosphate | | | | | | |

### Example 6 (EX6)

A coating solution was made by mixing 50.00 g calcium silicate powder, 81.55 g sodium silicate solution (42.92% solid) and 21.11 g dispersion of aluminum phosphate in water (66.67% solid) using a high shear mixer (Speedmixer DAC 600/Flack Tek Inc.). The solution was then coated onto a plastic release line with a coating gap of 3.2 mm and air-dried for 24 hours. Small pieces were removed from the release liner and further dried in an air convection oven according to the designated temperature profile in Table 4. The resultant coating was subjected to the Water-Sensitivity Test; results are summarized in Table 4.

### Example 7 (EX7)

A coating solution was made by mixing 100.00 g calcium phosphate powder, 174.74 g sodium silicate solution (42.92% solid) and 34.72 g dispersion of aluminum phosphate in water (72.00% solid) using a high shear mixer (Speedmixer DAC 600/Flack Tek Inc.). The solution was then coated on a plastic release line with a coating gap of 3.2 mm and air-dried for 24 hours. Small pieces were removed from the release liner and further dried in an air convection oven according to the designated temperature profile in Table 4. The resultant coating was subjected to the Water-Sensitivity Test; results are summarized in Table 4.

### Comparative Examples 1-5 (CE1-CE5)

A coating solution was made by mixing 65 g calcium silicate powder, 81.55 g sodium silicate solution (42.92% solid) and 5 g deionized water using a high shear mixer (Speedmixer DAC 600/Flack Tek Inc.). The solution was then coated on a plastic release line with a coating gap of 3.2 mm and air-dried for 24 hours. Small pieces were removed from the release liner and further dried in an air convection oven according to the designated temperature profiles in Table 4. The resultant coating was subjected to the Water-Sensitivity Test; results are summarized in Table 4.

TABLE 4
Coating Composition and Water-Sensitivity Test Results

| | | | Sodium | Aluminum | | |
|---|---|---|---|---|---|---|
| | | Filler | Silicate | Phosphate | | |
| | | Solid | Solid | Solid | | |
| Example | Filler | (wt. %) | (wt. %) | (wt. %) | Drying Profile* | Results |
| EX6 | Calcium | 50 | 35 | 15 | 95° C. × 30 minutes + | No |
| | Silicate | | | | 95° C.-120° C. (5 minutes) + | degradation |
| | | | | | 120° C. × 30 minutes + | in 2 weeks |
| | | | | | 120° C.-150° C. (6 minutes) + | |
| | | | | | 150° C. × 30 minutes | |
| EX7 | Calcium | 50 | 37.5 | 12.5 | 95° C. × 30 minutes + | No |
| | Phosphate | | | | 95° C.-120° C. (5 minutes) + | degradation |
| | | | | | 120° C. × 30 minutes + | in 2 weeks |
| | | | | | 120° C.-150° C. (6 minutes) + | |
| | | | | | 150° C. × 30 minutes | |
| CE1 | Calcium | 65 | 35 | None | 95° C. × 30 minutes + | Started to |
| | Silicate | | | | 95° C.-120° C. (5 minutes) + | disintegrate |
| | | | | | 120° C. × 30 minutes + | in 30 |
| | | | | | 120° C.-150° C. (6 minutes) + | minutes |
| | | | | | 150° C. × 30 minutes | |
| CE2 | Calcium | 65 | 35 | None | 85° C. × 24 hours | Started to |
| | Silicate | | | | | disintegrate |
| | | | | | | in 20 |
| | | | | | | minutes |
| CE3 | Calcium | 65 | 35 | None | 85° C. × 24 hours + | Started to |
| | Silicate | | | | 85° C.-100° C. (3 minutes) + | disintegrate |
| | | | | | 100° C. × 1 hour + | in 50 |
| | | | | | 100° C.-120° C. (4 minutes) + | minutes |
| | | | | | 120° C. × 1 hour | |
| CE4 | Calcium | 65 | 35 | None | 85° C. × 24 hours + | Started to |
| | Silicate | | | | 85° C.-100° C. (3 minutes) + | disintegrate |
| | | | | | 100° C. × 1 hour + | in 53 |
| | | | | | 100° C.-120° C. (4 minutes) + | minutes |
| | | | | | 120° C. × 24 hours | |
| CE5 | Calcium | 65 | 35 | None | 85° C. × 24 hours + | Started to |
| | Silicate | | | | 85° C.-100° C. (3 minutes) + | disintegrate |
| | | | | | 100° C. × 1 hour + | in 2 hours |
| | | | | | 100° C.-120° C. (4 minutes) + | |
| | | | | | 120° C. × 24 hours + | |
| | | | | | 120° C.-150° C. (6 minutes) + | |
| | | | | | 150° C. × 44 hours | |

*After air-drying for 24 hours.

Thus, the present disclosure provides, among other things, coatings and articles containing the coatings that can be used in high temperature applications where impact resistance and/or thermal transfer resistance are desired. Various features and advantages of the present disclosure are set forth in the following claims.

1. A coating comprising:
a filler;
an alkali silicate; and
a hardener,
wherein the filler comprises calcium silicate, zirconium silicate, calcium phosphate, or combinations thereof, and
wherein the hardener comprises ₄aluminum phosphate monobasic Al(H₂PO₄)₃, aluminum metaphosphate Al(PO₃)₃, non-stoichiometric aluminum phosphate [Al₂O₃]ₓ[P₂O₅]_{y}, magnesium phosphate monobasic, alkali metal bicarbonates (e.g., lithium bicarbonate, sodium bicarbonate, potassium bicarbonate), calcium chloride, calcium oxide, zinc chloride, zinc borate, calcium hydroxide, calcium sulfate, magnesium sulfate, aluminum sulfate, monosodium phosphate, sodium borate, boric acid, phosphoric acid, carboxylic acid, CO₂ gas, or combinations thereof.

2. The coating of claim 1, where the filler comprises calcium silicate, calcium phosphate, or a combination thereof.

3. The coating of claim 1, wherein the filler comprises calcium silicate.

4. The coating of claim 1, wherein the coating comprises 30-80 wt. % of filler based upon the percentage of solids in the coating.

5. (canceled)

6. The coating of claim 1, wherein the alkali silicate is an alkali metasilicate having the formula M₂SiO₃, wherein M is Na, K or Li.

7. The coating of claim 1, wherein the alkali silicate is a polysilicate having the formula M₂O(SiO₂)ₓ·yH₂O, wherein M is selected from Li, Na, or K, and x is between 1 and 15, and y is ≥0.

8. The coating of claim 1, where the coating comprises 20-70 wt. % alkali silicate based upon the percentage of solids in the coating.

9. The coating of claim 1, wherein the hardener comprises ₄aluminum phosphate monobasic Al(H₂PO₄)₃, aluminum metaphosphate Al(PO₃)₃, non-stoichiometric aluminum phosphate [Al₂O₃]ₓ[P₂O₅]_{y}, or combinations thereof.

10. The coating of claim 1, wherein the hardener comprises aluminum metaphosphate.

11. The coating of claim 1, wherein the coating comprises 10-30 wt. % hardener.

12. The coating of claim 1, further comprising fibers.

13. The coating of claim 12, wherein the coating comprises 1 wt. % to 30 wt. % fibers.

14-16. (canceled)

17. The coating of claim 1, further comprising defoamers, surfactants, rheological modifiers, forming aids, pH-adjusting materials, or combinations thereof.

18. The coating of claim 1, further comprising rheological modifiers comprising fumed silica, fumed titania, fumed alumina, or combinations thereof.

19. An article comprising:
a substrate having a first major surface and a second major surface opposite the first major surface; and
a hardened coating of claim 1 on at least the first major surface of the substrate.

20. The article of claim 19, wherein the substrate comprises flame resistant paper, an inorganic fabric, metals, or combinations thereof.

21. (canceled)

22. A method of making the article of claim 19, the method comprising:
mixing together the filler, the alkali silicate and the hardener to form a coating solution;
applying the coating solution to at least the first major surface of the substrate; and
hardening the coating solution by drying and curing the coating solution.

23. The method of claim 22, further comprising mixing fibers together with the filler, the alkali silicate and the hardener to form the coating solution.

24. (canceled)

25. A battery comprising:
a plurality of battery cells separated from one another by a gap; and
the article of claim 19 disposed in the gap between the battery cells.

26. A battery comprising:
a compartment lid having an inner and outer major surface, the inner major surface covering a plurality of battery cells; and
the article of claim 19 disposed on the inner surface of the compartment lid.
